(19) United States
(12) Patent Application Publication
(10) Pub. No.: US 2006/0027943 A1
(43) Pub. Date: Feb. 9, 2006

(54) Manufacturing method for a filament yarn and corresponding device

(75) Inventor: Arthur Rebsamen, Stallikon (CH)

Correspondence Address: DORITY & MANNING, P.A., POST OFFICE BOX 1449, GREENVILLE, SC, 29602-1449, US

(73) Assignee: MASCHINENFABRIK RIETER AG

(21) Appl. No.: 10/485,596

(22) Filed: Jul. 15, 2002

Related U.S. Application Data
(63) Continuation of application No. 10/485,597.

(51) Int. Cl. B29C 41/24

(52) U.S. Cl. 264/165

(57) ABSTRACT

The invention concerns a method for the manufacture of a filament yarn (10) or a fibril for a filament yarn by means of a spinning device, whereby at least two liquified components or materials (10a,b) are conducted through a number of capillaries (25a, 25c) to a spinning capillary (32), characterised in that the minimum of two liquified components or materials (10a,b) are conducted in each case through a number of capillaries (25a, 25c) to the spinning capillary (32), whereby a group of inner capillaries (25a) serve to form a connected filament core and whereby at least one further material (10b) forms a sheath around the filament core (10′a, 10″a).

The invention relates to a method, a device, and a yarn in accordance with the preambles of the independent claims.

There are numerous methods known for the manufacture of bicomponent yarns or yarns with several components, in which situation the requirement is for several components to be spun simultaneously, or for one component to be sheathed by other components, or for them to be mixed with one another. From U.S. Pat. No. 5,244,614 a device is known with which the inner component is guided through a single hole to the spinning nozzle; accordingly, the influence exerted on the building up of a filament fibril, and in particular of its core, is very restricted.

The problem of the present invention is to provide a yarn, consisting of at least two components, and a manufacturing method as well as a device, whereby, by the selection of the material components and their forming and shaping during spinning, individual properties can be achieved both in respect of their composition as well as in respect of their physical properties.

A further problem of the present invention is to extend the range of use of existing yarn production systems. Thus, for example, it may be to the purpose, depending on the level of orders in a system, for filament yarns to be manufactured optionally from three or even only from two components. The problem further arises, with the manufacture of yarns of which the individual fibres are made up of several components, for the material flows, directly before the formation of a filament or filaments respectively, for the part components to be controlled as precisely as possible in a large number of spinning nozzles, in order for the filament cross-section to maintain the desired form as precisely as possible.

This problem is resolved by the objects of the independent claims. The dependent claims relate to advantageous further embodiments of the method, the spinning device concerned, and the product(s).

A method is proposed for the manufacture of a filament yarn or of a fibril for a filament yarn respectively by means of a spinning device, whereby at least two different liquified components or materials are conducted through several capillaries to a spinning capillary or spinning nozzle, and whereby at least two liquified components or materials from at least one first and one second source are conducted to a distribution system with passage apertures, and further to a nozzle system. From the material flows from material sources of a number n, which are conducted to a melting plate or to the distribution system respectively, at least two flows, which are conducted for preference in a first and a third zone, are brought together through the melting plate, in at least one passage aperture or a part of the passage apertures respectively, whereby these passage apertures are in communication so that at the outlet from the distribution system, or at the inlet respectively into a connected perforated plate and/or a nozzle plate, referred to in general as the nozzle system, only material flows are present in a number less than n, said flows being divided in the nozzle system over a larger number of holes or spinning nozzles respectively, whereby the number of material flows amounts to n−x, with n≧3 and 1≦x<n−1 and with whole figure values for x and n. In this situation, a first material from a first source and a second source and a further material from a third source are conducted. The distribution system exhibits essentially a main passage aperture or main passage apertures communicating with each other, and a second main passage aperture or second main passage apertures communicating with each other, for the joint accommodation on the one hand of the material flows from a first and a second source in the first passage aperture, and, on the other hand, to accommodate a further material in the second main passage aperture. Materials from a first and a second source can also be conducted into a first main passage aperture or main passage apertures communicating with one another, and further materials from a third and, for example, a fourth source can be conducted to a second main passage aperture as well as to one or more further main passage apertures, so that only the material flows from the first and second sources are combined in a first main passage aperture. For the operator of such a system it is of advantage if the material flows from the individual sources are essentially kept at the same size, which means that components of the same type are installed.

Such a concept has the advantage that different mass distributions in the end product, i.e. the filament yarns or the individual fibrils can be achieved by equally large delivery components of the material, i.e. extruders, spinning pumps, or spinning pots. If, for example, with a bi-component yarn, it is intended that double the material quantity should be present in the filament core in comparison with the material quantity in the sheath of this yarn, there is no need to make provision for delivery components of different size for the core material or the sheath material, but instead several components of the same type are used for the delivery of this material, which in comparison with another material are consumed in a greater amount during the spinning process.

In a further embodiment of the invention, a merger of at least two material flows takes place upstream of the actual distribution system into one single flow, so that instead of the original n number of flows from n sources, the result is n−x flows at the inlet of the distribution system, with n≧3 and 1≦x<n−1 and with whole numbers for x and n.

In addition to this, a method is proposed for the manufacture of a filament yarn or a fibril for a filament yarn respectively, whereby at least two liquified components or materials are conducted through several capillaries of a spinning capillary or spinning nozzle, and whereby the minimum of two liquified components are conducted in each case through several capillaries of the spinning capillary and a group of internal capillaries serves to form a connected filament core, and a further material in the outer capillaries surrounds the filament core. In this context, the material flows combine in the first capillaries in the centre thanks to their special guidance arrangement in such a way that the flows of a first material combine to form a connected core consisting of a filament core and at least one filament flyer connected to this. A further material in further capillaries in the area surrounding the first capillaries is conducted in such a way that the further material is in contact with the core and at least in part surrounds it.

The invention is described in detail hereinafter on the basis of the drawings, whereby the manufacture of a number of individual fibrils of a yarn is explained in several embodiments. It is understood that with most applications several fibrils are combined to form one yarn, even if the possibility is not to be excluded that a yarn consists of one single fibril, which for preference is formed from several components For the sake of simplicity, the fibrils are designated hereinafter as yarn or filament yarn.

The Drawings Show:

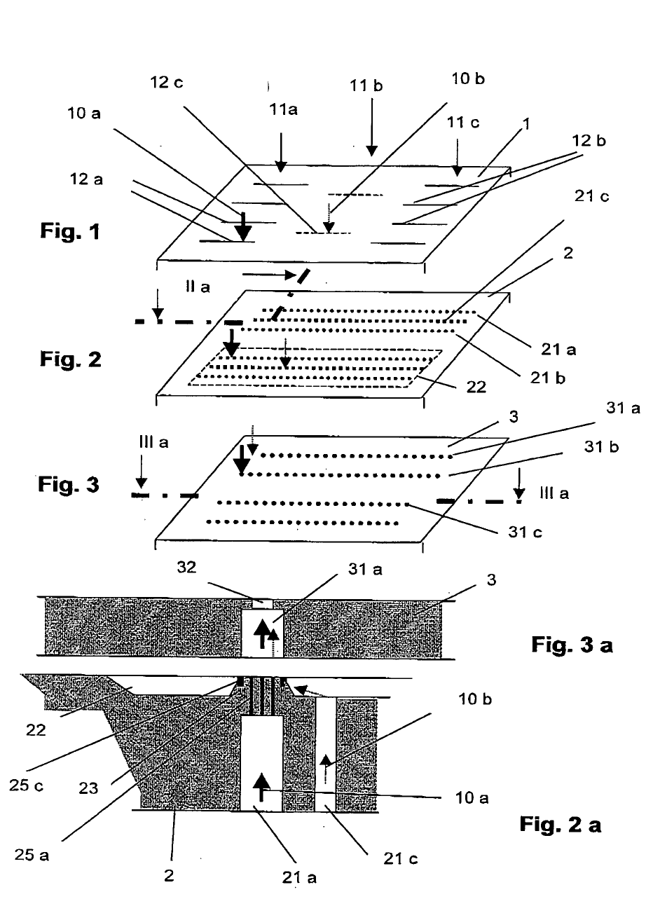

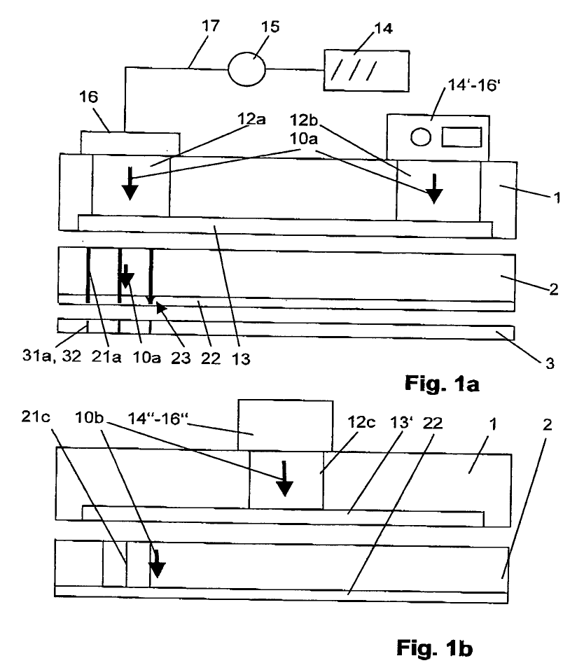

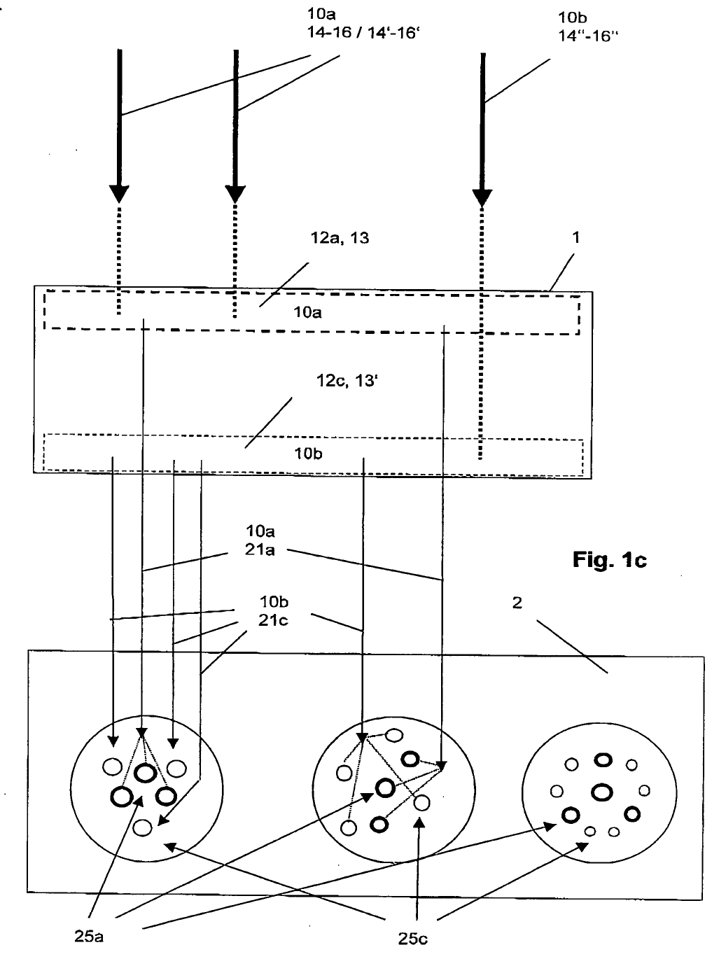

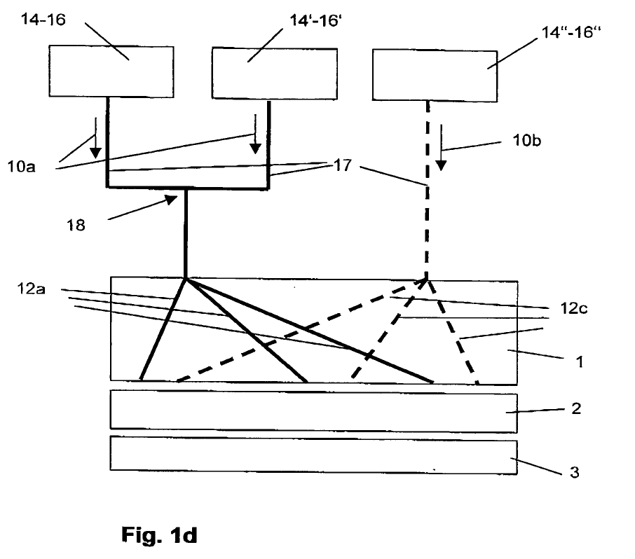

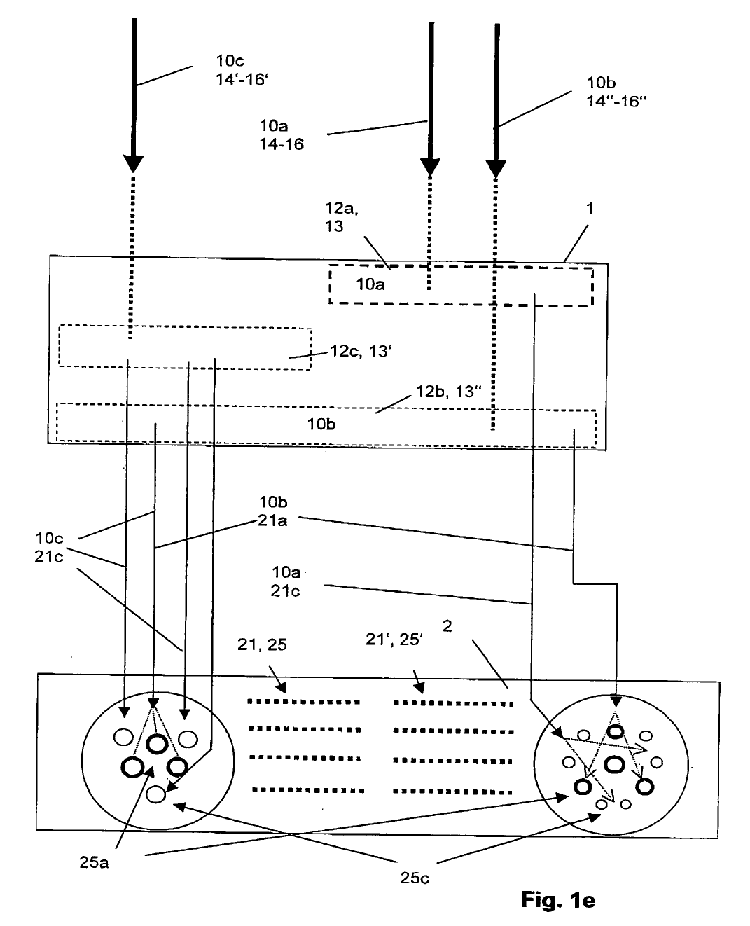

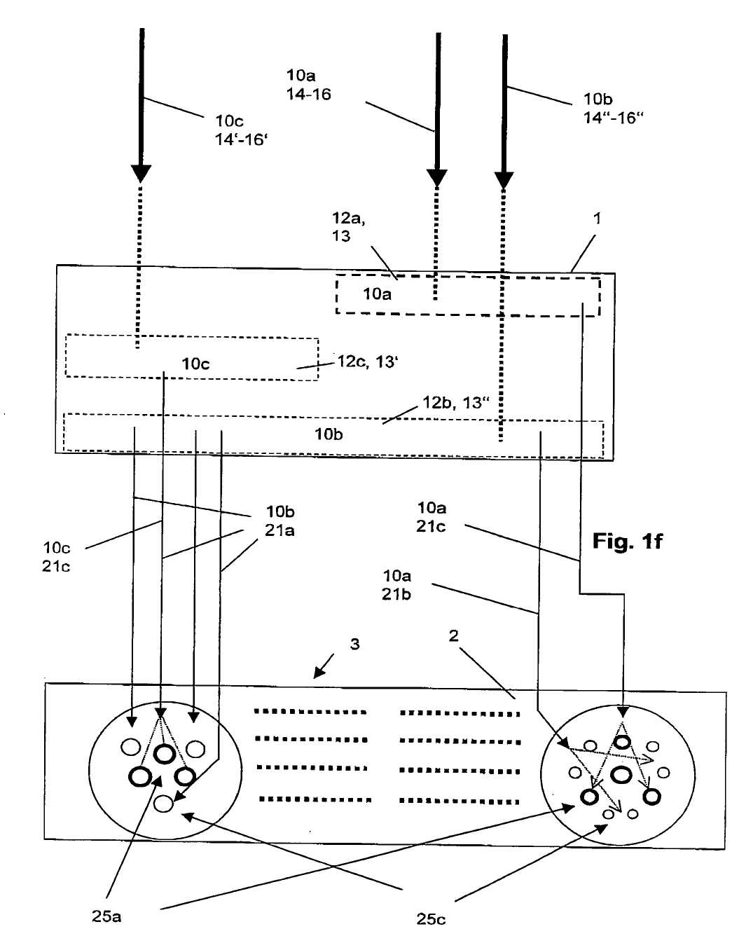

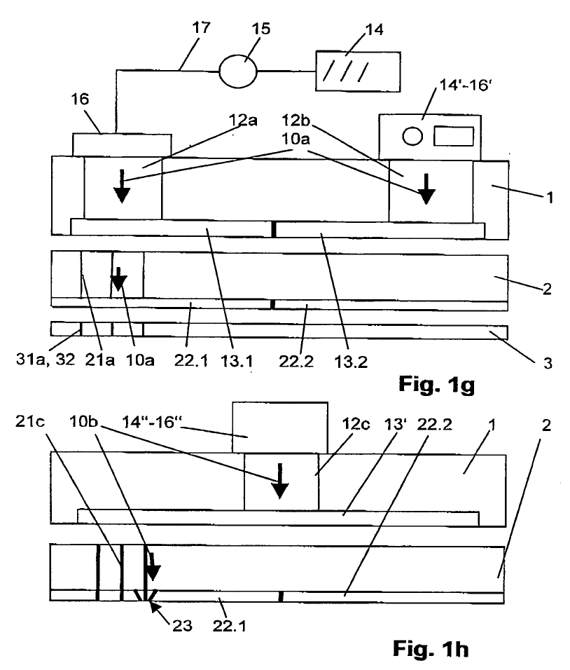

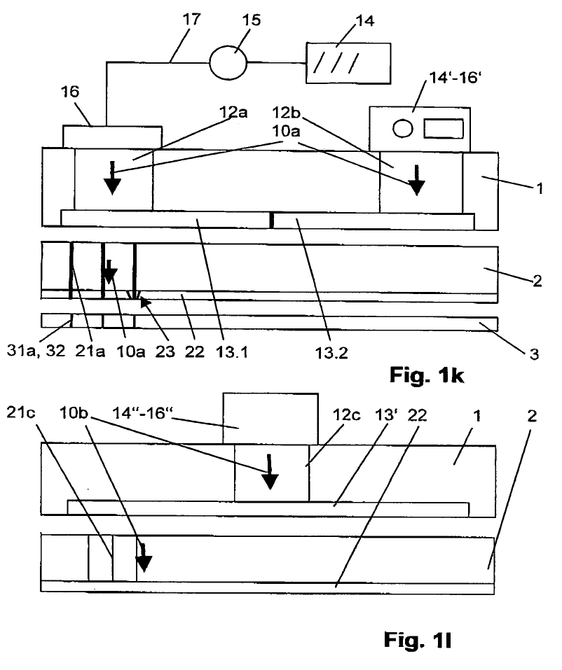

FIGS. 1,2,3 Components of a spinning device, which can be combined to form a spinning unit,

FIGS. 1 a,b Diagrammatic representations of the components in overview drawings,

FIG. 1c A diagram of the material flows from the sources as far as the spinning capillaries at the spinning nozzles,

FIG. 1d A diagram of a further material delivery,

FIG. 1e A derivation of the embodiment shown in FIG. 1c,

FIG. 1f A further derivation of the embodiment,

FIG. 1g A derivation of the embodiment according to FIG. 1a,

FIG. 1h A derivation of the embodiment according to FIG. 1b,

FIGS. 1k+1l Further derivations of the embodiments according to FIGS. 1a,b,g,h,

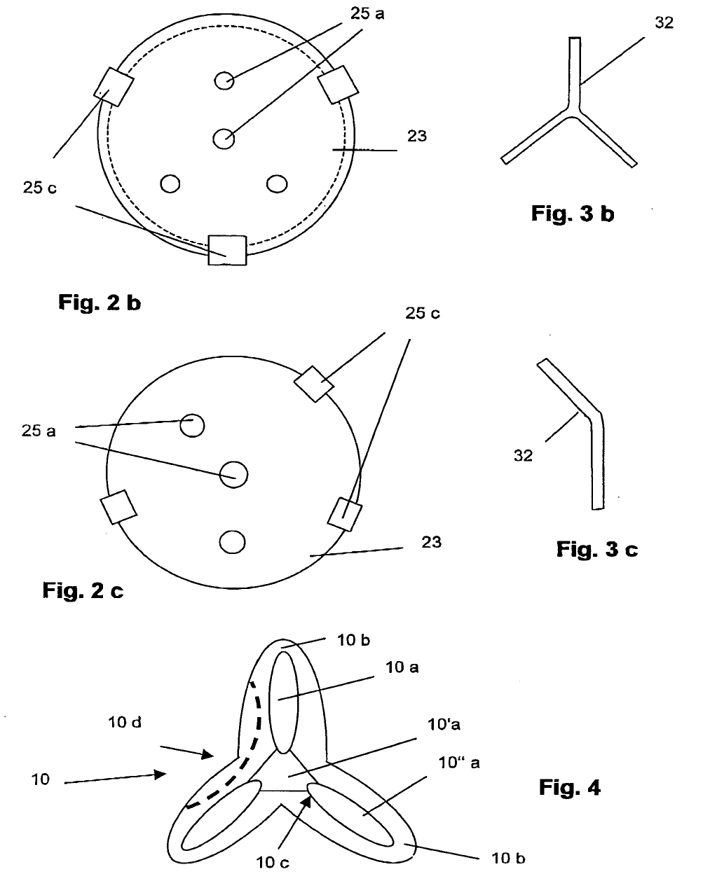

FIG. 2a A section through a component from FIG. 2,

FIG. 2b A plan view of a part of this component,

FIG. 2c A plan view according to another embodiment,

FIG. 3a A section through a component according to FIG. 3,

FIGS. 3b, 3c Two embodiments of spinning nozzles, and

FIG. 4 A cross-section through a filament yarn, which can be manufactured with a component according to FIG. 2b.

### Object of the Invention in a First Embodiment

The invention relates to a method for the manufacture of a filament yarn 10, or a fibril for a filament yarn respectively, by means of a spinning device, whereby at least two liquified components or materials 10a,b are conducted through several capillaries 25 a, 25 c of a spinning capillary 32, characterised in that the minimum of two liquified components or materials 10 a,b are in each case conducted through several capillaries 25 a, 25 c of the spinning capillaries 32, whereby a group of internal capillaries 25 a serve to form a connected filament core, and whereby a further material 10b surrounds the filament core 10′a, 10″a.

The material flows 10a in the first capillaries 25 a in the centre of a spinning unit can be conducted in such a way that the flows of a first material 10 a combine to form a connected core consisting of a filament core 10′a and at least one filament flyer 10′a connected to this, whereby a further material 10b is conducted into further capillaries 25 c in the surrounding area of the first capillaries 25 a in such a way that the further material 10 b is in contact with the core and surrounds it at least in part.

The components can consist of at least one first material 10 a and a second material 10 b, whereby the materials in liquified form emerging from the capillaries 25 a, 25 c are conducted in parallel through a first hole 31 a, in order then to be pressed jointly through the spinning capillary 32 and forming a fibril or a yarn 10 respectively.

A component 10 a for the core of the filament yarn 10 is conducted through the central capillary 25a and further peripheral capillaries arranged at a uniform distance around this to core capillaries 25a, and a further component 10 b is conducted through sheath capillaries 25c, which are located further away from the central capillary, between the peripheral core capillaries.

The first material 10 a is conducted through central core holes 21 a, b of an extruder, and the second material is conducted through peripheral sheath holes 21 c of the spinning device.

The components 10a, 10b are conducted through a distribution plate or melting plate 1, whereby the first material 10 a is divided in a first zone 11 a and a third zone 11 c, and the second material 10 b is divided in a second zone 11 d, into material flows, whereby the material flows enter in an ordered manner through slots on the inlet side of the melting plate 1, and pass through a second slot 12c communicating with this, on the underside of the melting plate, into the capillaries 25 a and 25 c.

The invention likewise relates to a device for the manufacture of one or more fibrils or filament yarns 10 respectively, whereby first capillaries 25 a are arranged in the centre of a spinning unit, for guiding flows of a first material 10 a, and whereby further capillaries 25 c for at least one further material 10 b are arranged in the area surrounding the first capillaries 25 a, and whereby all the capillaries communicate with a spinning capillary 32, characterised in that the first capillaries 25 a are arranged in the centre of a spinning unit in such a way that the flows of a first material 10 a combine to form one connected core consisting of a filament core 10′a and at least one filament flyer 10″a connected to this, and that further capillaries 25 c for a further material 10 b are arranged in the area surrounding the first capillaries 25 a in such a way that the further material 10 b is in contact with the core and at least in part surrounds this.

### Object of the Invention in a Further Embodiment

In a general formulation, the invention comprises a method for the manufacture of a filament yarn 10, or a fibril for a filament yarn respectively, by means of a spinning device, whereby at least two different liquefied components or materials 10a,b, which derive from at least one first and one second source 14-16/14′-16′, are conducted to a distribution system with passage apertures 12 a,b,c, 13, 13′, in particular to a melting plate 1, and further to a system of holes and nozzles 2, 3, in particular through several capillaries 25 a, 25 c, to a number of spinning capillaries 32, characterised in that, of the material flows from n sources 14-16/14′-16′, which are conducted to a distribution system 1, or to a melting plate respectively, at least two flows 10 a are merged, so that at the inlet into a nozzle system 2/3 only n−x different material flows 10 a, 10 b are present, which are divided in the nozzle system 2/3 onto a larger number of holes 21 a, 21 c or nozzles 32 respectively, with n≧3 and 1≦x<n−1, and whole figure values for x and n.

Formulated in a general manner, the invention relates to a method and device for the manufacture of a filament yarn 10, or a fibril for a filament yarn respectively, by means of a spinning device, whereby at least two different liquified components or materials 10 a, 10 b are conducted through several capillaries of a spinning capillary 25 a, 25 c or spinning nozzle 32, and whereby at least two liquified components or materials 10 a, 10 b from at least one first and one second source 14-16, 14′-16′, are conducted to a distribution system with passage apertures, and further to a nozzle system 3, characterised in that, from the material flows 10 a, 10 b from n sources 14-16/14′-16′, which are conducted to a distribution system, at least two flows are combined, and are conducted to at least one passage aperture 12 a, 13, or system of passage apertures, while at least one further material flow 10 b from a further source 14″-16″ is conducted separately to the distribution system 1, so that n material flows 10 a, 10 b from n sources 14-16, 14″-16″, 14′-16′ are combined in such a way that in further processing only n-x different material flows are spun to form filaments in each case in the passage apertures 12 a, 12 c, which communicate with one another, of a distribution system 2 and of a nozzle system, and the filaments are composed in the final analysis only of n−x different materials or material mixtures respectively.

Two different liquefied components or materials 10′a, 10 b, which derive from at least one first and one second source 14-16/14′-16′, are conducted to a distribution system with passage apertures 12 a, b, c, 13, 13′, in particular to a melting plate 1, and further to a system of holes and nozzles 2, 3, in particular through several capillaries 25 a, 25 c, to a number of spinning capillaries 32, characterised in that, of the material flows from n sources 14-16/14′-16′, which are conducted to the melting plate or to the distribution plate 1, at least two flows 10 a, which for preference are conducted in a first zone 11 a and a third zone 11 c, are combined in at least one passage aperture, or in a part of the passage apertures 12 a, 12 c respectively, so that at the outlet from the distribution system 1, or at the inlet into a following perforated plate 2 and/or a nozzle plate 3 respectively, referred to in general as the nozzle system 2/3, only n−x different material flows 10 a, 10 b are present, which in the nozzle system 2/3 are divided over a larger number of holes 21 a, 21 c, or nozzles 32 respectively, with n≧3 and 1≦x<n−1, and whole figure values for x and n.

A first material 10 a is conducted from a first source 14-16 and a second source 14′-16′ and a further material 10 b from a third source 14″-16″, and the distribution system exhibits essentially a first main passage aperture 12 a, 13, or main passage apertures 12 a, 13, 12 b communicating with one another, and a second main passage aperture 12 c, 13′, for the joint accommodation of the material flows from the first and second source in the first main passage aperture 12 a, 13, and to accommodate the material 10 b in the second main passage aperture 12 c, 13′.

Materials 10 a from a first and a second source 14-16, 14′-16′ are conducted in a first passage aperture 12 a, 13, or main passage apertures 12 a, 13, 12 b, communicating with one another, and further materials from a third and a fourth source 14″-16″, 14′″-16′″ are conducted to a second main passage aperture 12 c, 13′, as well as to a third main passage aperture 12′c, 13″, so that only the material flows 10 a from the first and second source are combined in a first main passage aperture 12 a, 13.

The material flows from the individual sources 14-16, 14′-16′ are for preference essentially of the same size.

The invention also relates to a pertinent device for the manufacture of a filament yarn 10 or a fibril for a filament yarn respectively, by means of a spinning device, whereby at least two different liquified components or materials 10 a, 10 b can be conducted through several capillaries 25 a, 25 b to a spinning capillary 32, and whereby at least one first and one second source 14-16/14′-16′ are located upstream of a distribution system 1 for melting flows of the materials 10 a, 10 b, and passage apertures 12 a, 12 b, 12 c, 13, 13′ are arranged in the distribution system 1, which communicate with a nozzle system 3 for spinning out filaments, characterised in that a number of n sources 14-16, 14′-16′ are connected to the distribution system 1 in such a way that at least two of the sources 14-16, 14′-16′ communicate with a first system of main passage apertures 12 a, 13, 12 b, so that the material flows from both the sources referred to mix in the system, and that at least one further source 14″-16″ is present, which passes into another, second system of main passage apertures 12 c, 13′, not communicating with the first system.

The distribution system 1 exhibits essentially a first system of main passage apertures 12 a, 13, 12 b, communicating with one another, as well as a further system of main passage apertures 12 c, 13′, not communicating with the first system.

Located upstream of the distribution system 1, in several embodiments, is in each case a flange or spinning pot 16, and upstream of this in turn is an extruder 14, whereby at least two extruders 14, 14′ and downstream components referred to, 15, 15′, 16, 16′, open into a common main passage aperture 13, or part passage apertures 12 a, 12 b, respectively, which communicate with each other.

At the distribution system 1, on the inlet side, one or more slots or passage apertures 12 a, 12 b are allocated to one or more spinning pots 16, 16′, said passage apertures opening into a longitudinal slot 13, and a further system of slots 12 c is provided for, on the inlet side of the distribution system 1, which opens into a further longitudinal slot 13′.

A first system of passage apertures 12 a, 12 b, 13, which communicate with one another, which is connected to at least two sources 14-16, 14′-16′, communicates with a system of core holes 25 a, which are aligned with the central areas of spinning nozzles 32, and another system of passage apertures 12 c, 13′ of the distribution system 1, which communicates with a further source 14″-16″, passes into further holes or sheath holes 21 c, which are aligned with the peripheral areas of spinning nozzles 32.

The spinning nozzles 32 exhibit two-armed or multi-armed capillaries 32 in FIG. 3 b, for the production of multi-component filaments 10.

### Object of the Invention in a Third Embodiment

Main elements of the device for the manufacture of one or more fibrils, or filament yarns 10 respectively, are capillaries 25 a in the centre of a spinning device 3, for the guidance of flows of a first material 10 a, and further capillaries 25 c for at least one further material 10 b in the area surrounding the first capillaries 25 a, characterised in that the capillaries 25 a, 25 b are in a perforated plate 2, which is located at a nozzle plate 3 with spinning nozzles or spinning capillaries 32 respectively, whereby in each case, aligned with a spinning capillary 32, a projection 23 is located on the side of the perforated plate 2 which is turned towards the spinning capillaries 32 or the nozzle plate 3 respectively, said projection 23 covering a hole 31 a, which passes into the spinning capillary 32, whereby central capillaries 25 a run in the centre of the projections 23 and more open into the middle area of the first hole 31 a, while other capillaries 25 c are located at the edge of a projection 23, in such a way that through these capillaries 25 c a connection is established between a trough 22 in the perforated plate 2, turned towards the nozzle plate, and the space of the first hole 31 a.

Located upstream of the perforated plate 2 is a distribution system 1, whereby the central capillaries 25 a communicate with a first system of main passage apertures 12 a, 12 b, 13 of the distribution system 1, said passage apertures being fed jointly from at least two sources 14-16, 14′-16′, and whereby the other peripheral capillaries 25 c are connected to a further system of main passage apertures 12 c, 13′ of the distribution system 1, which are connected to a further source 14″-16″.

In a preferred embodiment, material components are processed with the method or devices 2, namely polyesters for the core of the yarn and polyamide as the sheathing for the yarn.

Usually, the material components are conducted through several extruders of the spinning device, which is composed, among other parts, of a melting plate 1, a perforated plate 2, and a nozzle plate 3. According to FIG. 1, a melting plate 1 is subdivided into a first zone 11a, a second zone 11b, and a third zone 11c. Conducted in the area of the first zone 11a and the third zone 11c is a core melt, i.e. liquified material, for forming the core of the filament yarn, and in the zone 11b a sheath melt, i.e. material for forming the sheath of the filament yarn. This configuration is selected if twice as much material in terms of order of size is to be arranged in the core than in the sheath of the filament yarn. Conversely, if the core of the filament yarn is intended to be weak, and a voluminous sheath is to be striven for, it is to advantage for the sheath material to be guided in two zones 11 a and 11 c, and for the core material to be guided only in one single zone 11 b. It is in any event to the purpose for an extruder to be provided for per zone 11 a, 11 b, 11 c, so that operations can be carried out with the same devices. This makes it possible, for example, for manufacture to be carried out, with a manufacturing system for three-coloured yarn, tricolour yarn, of a bi-component yarn, a two-component yarn, i.e. a yarn with at least two materials

FIG. 1 a shows a principle representation of different material flows. From an extruder 14, material 10 a, indicated by an arrow in a first distribution system 12A, 13, is conducted by means of a spinning pump 15 and a flange or spinning pot 16 to a first slot 12 aor several slots located one behind another, as represented in FIG. 1. A further material component is conducted through a corresponding delivery system 14′-16′ to a second slot 12 b, or respectively through several slots 12 b located one behind another. According to the example in FIG. 1 a, this involves the same material as in the slot 12 a. The material flows from the slots or shafts 12 a and 12 b can then expand in a longitudinal slot 13 on the underside of the first distribution system 1. Per slot 12 a or 12 b respectively, therefore, there are located on the underside of the melting plate 1 a longitudinal slot 13, which is aligned with a row of holes 21 a, according to the embodiment in FIGS. 2 and 3 referred to as core holes, i.e. for the core melt of the filament. There are as many rows of core holes 21 a as there are slots 12 a or 12 b respectively. Further, the material passes out of the core holes 21 a into first holes 31 a, or spin capillaries 32 respectively, in a connected third nozzle plate 3, whereby the material, if this involves core material for the filament, is conducted in the centre of the spinning capillary.

As is represented in FIG. 1 b, there is a further guidance system 14″-16″ at the inlet into a slot system 12 c in the plate 1, through which material 10 b, in the embodiment for the filament material, is conducted. The conducting system 14″-16″, like the other conducting systems 14-16 and 14′-16″, is made up of an extruder, a spinning pump, and a spinning pot with connected lines 17. This conducting system is also referred to as the sources for the material which is to be spun. According to FIG. 1 there are two slots 12 c, which accommodate the material from a spinning pot 16″ according to FIG. 1b, which, after flowing through the slots 12 c, passes into another longitudinal slot or slots 13′, which are located between the first longitudinal slots 13 referred to heretofore. The material 10 b can be distributed in the second longitudinal slots 13′ over the entire width of the melting plate 1 and passes on further into what are referred to as sheath holes 21 c, from where it cam be divided into a trough 22 on the underside of the perforated plate 2, as is also shown in FIGS. 2, 3, 2a, 3a. This material 10 b can then enter into the spinning capillaries 32 at the outer edge of projections 23 on the underside of the perforated plate 2, in accordance with FIG. 2a, 3a, in first holes 31 a and then in the peripheral areas, where this material forms the sheath 10b of the filament according to FIG. 4. FIGS. 1 and 1 b show only a rough overview of the distribution of the material. The details of the material guidance are explained in FIGS. 2, 3, 2 a and 3 a.

In FIG. 1, material flows are symbolised, as in the other figures, by one boldly extended and one broken-line arrow, whereby the first arrow represents the direction of flow of the core melt of the first material 10 a, and the second arrow represents the sheath melt, i.e. the second material 10b. The first material 10a can penetrate through slots or apertures 12a in the first zone 11a through the melting plate 1, and likewise through slots 12 b on the other side of the plate. In each case, four slots or passage apertures 12a and 12b are represented. In between, the sheath melts or the second material 10b in the middle area of the melting plate can pass downwards through two slots or apertures 12c. On the underside of the plate are slots or indentations, which extend essentially horizontally over the entire longitudinal extension of the melting plate 1, whereby the bottom slots on the one hand communicate with the upper slots 12a and 12b, and other longitudinal slots on the underside communicate with the upper slots 12c. The longitudinal slots on the underside must not pass into one another, since at this stage the core melts or the sheath melts must be conducted separately to the components. Because, in the embodiment according to FIG. 1, 2×4=8 slots are provided for the core melts and two slots for the sheath melts, there are six slots on the underside of this plate, of which four serve to guide the core melts and two to guide the sheath melts.

According to FIG. 2, aligned with these slots are six rows of holes 21 a, b, with core holes and sheath holes 21c, whereby the sheath holes are in each case located between two core holes. On the underside of the perforated plate 2, with the holes referred to, are two troughs 22, of which one is indicated in the front part of the plate by a broken line. Into these troughs 22 open the sheath holes 21c referred to, whereby in each case a row of holes of this type are provided for one trough. The other core holes 21a, 21b open on the underside in projections 23, which project from the two troughs 22. In FIG. 2, in turn, the flows of the core melts or the sheath melts respectively are characterised by the individual part in each case, whereby the core melts flow through holes 21a, 21b and the sheath melts pass through holes in a row 21c.

After the emergence of the melt flows from the perforated plate 2, the material passes into the area of the nozzle plate 3, whereby rows of holes 31a, 31b, 31c etc are in each case located aligned with the rows of holes of the perforated plate 2, which are formed by the core holes 21a, 21b. The extruded material, the core melts, and the sheath melts, and, if appropriate, also additional melt components, leave the nozzle plate 3 through spinning nozzles or spinning capillaries 32, of which one single one is represented in FIG. 3a. The filament emerging through the capillaries from at least two components are conducted to a processing stage before it is further processed and wound up.

In FIGS. 2 and 3 there are sectional lines IIa and IIIa, with which the sectional representations in FIGS. 2a and 3a are defined. It is to be noted that the sections through the perforated plate 2 and the nozzle plate 3 according to FIGS. 2a and 3a respectively are, in a manner of speaking, stood on their heads, which is also expressed by the inverted direction of flow of the arrows symbolising the core melt or the sheath melt respectively. In FIGS. 2a and 3a, only one section in each case of a plate with flows in the direction of an individual spinning capillary 32 is represented. The material of the core melt penetrates into a core hole 21a from below into the perforated plate 2 and branches into several core capillaries 25a, which lie aligned with a first hole 31a of a third row of holes. Connecting to this first hole 31a on the outlet side of the nozzle plate according to FIG. 3a is a spinning capillary or spinning nozzle 32. According to FIG. 2a, the second material 10b or the sheath melt flows through a sheath hole 21c from top to bottom into the trough 22, where the sheath melt can be distributed around the projection 23 or projections 24 respectively. Located at the edge of each projection 23 is a cut-out, i.e. a sheath capillary 25c, which is located at the edge of a projection 23 in such a way that, when the perforated plate 2 and the nozzle plate 3 are pressed together, the edge of a first hole 31a on the inlet side surface of the nozzle plate 3 lies precisely at the height of the sheath capillary 25c, i.e above this cut-out, so that the sheath melt or the second material 10b respectively can pass from the trough 22 through the sheath capillary 25a at several points, according to the number of cut-outs, into the first hole 31a at its edge, while the core material or the first material 10a passes through the core capillaries 25a into the first hole more towards the middle. The arrows in the first hole 31a according to FIG. 3a indicate that the first material 10a, i.e. the core melt, is located more in the centre of the first hole, while the second material 10b, i.e. the sheath melt, flows in the peripheral area of the first hole 31a.

In FIG. 1 c, principle overviews are shown of possible routes of the material flows from the material sources 14 to the spinning nozzles 32 or spinning capillaries respectively. According to FIGS. 1 c and 2a, 3a, a first and a second material flow, in each case with the material 10 a, in particular for forming the filament core, pass into a first main passage aperture 12 a, 13, and from this further via core holes 21a into the area of core capillaries 25a in the perforated plate 2, in order to form the material core of the filament or the plurality of filaments respectively. Further, a third material flow from the source 14″-16″, namely the material 10b, is conducted into another distribution system or into further main passage apertures 12 c, 13′, in order from there to pass through what are referred to as sheath holes 21 c through the perforated plate 2 and then likewise into spinning nozzles or spinning capillaries 32 respectively. The first part flow 10 a therefore passes in each case into the centre of the spinning nozzles 32 via the core capillaries 25 a, while the second material flow 10b from the source 14″-16″ passes through peripheral sheath capillaries 25 c to the first holes 31 a or spinning nozzles 32 respectively. Different configurations of the core capillaries 25 a and sheath capillaries 25 c respectively are represented in the lower part of FIG. 1 c.

According to FIG. 1d, material flows 10a, 10a are collected via lines 17, 17 from two sources 14-16, 14′-16′ in a collector 18, before they pass into the distribution system 1 Another material flow 10b also flows separately directly into the distribution system 1 and, like the combined material flows 10a, 10a, passes through passage apertures 12c or 12a respectively, as described elsewhere, into the perforated plate 2 and the nozzle late 3.

It has transpired surprisingly that the material flows from the core capillaries 25a and the sheath capillaries 25c do not mix or overlay, but flow through the first hole 31a precisely in its axial direction, even if the length of this hole 31a amounts to several times its diameter. The perforation pattern of the core capillaries 25a and the sheath capillaries 25c respectively must be matched precisely to the shape of the spinning capillaries or spinning nozzle 32, as is explained hereinafter on the basis of FIGS. 2b and 3b, in order to result in a filament with the desired properties. In the embodiment of the hole pattern according to FIG. 2b and of the spinning capillaries according to FIG. 3b, there are four core capillaries 25a, which are arranged in a star shape, whereby one core capillary 25a is located in the centre of a projection 23 and three further core capillaries 25a are distributed somewhat like satellites around this middle core capillary 25a, in particular in a uniform distribution. In the areas between the outer core capillaries 25a, the passage apertures or sheath capillaries 25c are located at the edge of the projection 23 according to FIG. 2b, through which the sheath melts can flow in the direction of the first hole 31a.

In FIG. 3b, for the configuration of capillaries and holes or passage apertures respectively, according to FIG. 2b the shape of the spinning capillaries 32 is represented with three wings or lobes. Since, as mentioned, the material flows from the core capillaries 25a or sheath capillaries respectively within a first hole 31a maintain their relative positions to one another, the materials of the sheath melts flow along the edge of the first hole 31a in the peripheral areas also, through the clear cross-section of the capillaries 32, i.e. in the outer areas of the wings, while the core melts are located in the inner areas of the wings of the capillaries 32 and in their centre.

FIG. 4 shows the composition of such a filament yarn, which is also referred to as a trilobal yarn according to the English literature. From FIG. 4 it can be seen that in the interior of the cross-section of a filament yarn 10 there are laid four areas of the core material or the core melts or of the first material 10a, whereby a filament core is located in the centre, located on which are filament wings 10a or 10a″ respectively. In FIG. 4 taperings 10c can be seen between the filament wings 10a and 10″a respectively and the filament core 10′a. The boundary lines between the filament core 10′a and a filament wing 10a or 10″a are drawn in arbitrarily, whereby the material flows merge into one another at the transition points between filament core 10′a and filament wing 10″a. According to the embodiment in FIG. 10, the core material 10a is encompassed completely by the sheath material 10b, whereby the broken line at 10d in the left part of FIG. 4 indicates that taperings 10d are also possible in the second material of the sheath melts 10b. Depending on how large the sheath capillaries 25c are designed, the material distribution can be determined, which is located on the outside at the core material 10a. It is conceivable that, with the arrangement of the sheath capillaries 25c, more in the vicinity of the core capillaries 25a, in extreme cases therefore at their periphery, the second taperings 10d are so marked that, according to FIG. 4 at 10d no sheath material or material from the sheath melts is in contact with the core material 10a at all, so that at 10d this material lies freely towards the outside. This can be advantageous for certain applications. With the corresponding design of the capillaries in the projections 23 it is also possible for the material flows from the core capillaries 25a and the sheath capillaries 25c to combine with one another only at specific points, such as entirely on the outside of the filament wings 10a or 10″a respectively, whereby the material of the sheath melts can also split off from the filament wings 10a and 10″a.

It is of course possible, instead of four core capillaries 25a and three sheath capillaries 25c to arrange more or even fewer such capillaries, as a result of which other yarn cross-sections with more than three or less than three wings can be formed. In FIG. 2c three core capillaries 25a are shown, which together form an obtuse angle, and in the surrounding area of which three sheath capillaries 25c are located, of which one lies inside the area of the obtuse angle between the core capillaries 25a and the other two sheath capillaries 25c are located at a complementary angle to this obtuse angle. The corresponding spinning capillary is represented in FIG. 3c. By correct dimensioning of the capillaries 25a and 25c it is possible, in a similar manner to FIG. 4, to manufacture a filament yarn with two wings, in contrast to the three wings in FIG. 4, whereby in each case a filament wing 10a is connected via a filament core 10′a with a further filament wing 10″a, and these three elements of the filament core are enclosed more or less by a sheath from the three sheath capillaries 25c according to FIG. 2c. Such a two-winged filament yarn with a cross-section similar to the shape of the spinning capillaries 32 according to FIG. 3c exhibits specific properties which can be advantageous in the further processing of the filament.

The spinning method and the device according to the foregoing Description are characterised in particular in that a filament yarn is created with at least a partial sheathing, whereby the actual material core of this filament, consisting of one or more core melt materials, exhibits more or less marked taperings at the transition points between the filament wings 10″a and the filament core 10′a, as a result of which a soft grip or high flexibility of the filament yarn can be achieved, which leads to advantageous product properties during the further processing of the filament and in the corresponding end product respectively.

### Object of the Invention in a Fourth Embodiment

According to a further embodiment of the invention, it is proposed that a spinning package, consisting of a distribution system 1, a perforated plate 2, and a nozzle plate 3 are designed in such a way that several, i.e. n(n≧3), components are introduced, and these n components are divided in separate sheath flows over a plurality of holes, so that on the outlet side of the spinning package 1, 2, 3 according to FIGS. 1 g, 1 h, 1 k, 1 l, or according to FIG. 1 e and 1 f respectively, the part material flows are driven out of a nozzle system in such a way that n−x (x≦n−1) yarn types are formed. In this situation, these may be differently coloured yarns and/or such yarns as are made up of different yarn components. Less than n different yarns are then produced from n different material components at the inlet of the spinning package.

This involves a method for operating a spinning machine for the manufacture of different yarns or yarn types respectively in groups, whereby in each case an identical make-up of the yarns from different material components pertains in each case in a yarn type or a group of yarns, for preference with several extruders, from which different materials 10 a, 10 b can be conducted to one or more spinning packages 1, 2, 3, said spinning package or spinning packages exhibiting at least one distribution system 1, 2 with a distribution plate and spinning nozzles 32, whereby indentations 12 c, or 12 a respectively, are present in the spinning package in order to accommodate the materials, characterised in that at least one first material 10 c for a first component of a first yarn type can be conducted into at least one indentation or indentations, which extend only over a part of the spinning package, and that for further yarn types, which can include the first yarn type, and which are spun from a plurality of spinning nozzles 32, at least one further material 10 b can be introduced into at least one indentation 12 b, from where this material can be distributed over a larger or the entire extent of a distribution system 1, 2, 3, in order to pass in individual holes 21 of a distribution plate 2 to the spinning nozzles 32 concerned.

A spinning machine to carry out the foregoing method for the manufacture of different yarns in groups, whereby in each case an identical make-up of the yarns from different material components pertains in each case in a group of yarns, with several extruders, from which different materials 10 a, 10 b can be conducted to one or more spinning packages, said spinning package or packages exhibiting at least one distribution system with a distribution plate with indentations and spinning nozzles, is characterised in that at least one indentation or a system of indentations respectively 12 c or 12 a is present in the distribution system of the spinning package to accommodate at least one first material component for a component of a yarn type from a large number of spinning nozzles 32, which extend only over a limited part of a spinning package, and that, for further or all yarns which are to be manufactured, a further inlet indentation 12 b is provided, from which a further material can be distributed over a larger extension of the distribution system 1 in a larger part of the system or in the entire system, in order to pass into individual holes 21 of a distribution plate 2 to a larger part of indentations in comparison with the indentations of the first material, or, in the final analysis, to pass to all the indentations or spinning nozzles 32 respectively.

A possible configuration is shown in FIGS. 1 g and 1 h, whereby essentially the situation as in FIG. 1 a and 1 b is provided, with the difference that, from the material sources 14 to 16 and 14′ to 16′, the material or different materials respectively are conducted for the sheaths of multicomponent yarns, and only the individual component 14″ to 16″ according to FIG. 1 h is used to form the core of the filament yarn. It is of course possible for several material sources for different core materials to be arranged, as is the case in FIG. 1 g for the conducting of different sheath materials. By contrast with the remarks made with regard to FIG. 1 a, according to FIG. 1 g at least two spinning pots 16/16′ with different materials are provided at the inlet into the distribution system 1. These different materials pass through the slots 12 a and 12 b into a chamber 13.1 or 13.2 respectively in each case, also referred to as longitudinal slots. The different materials 10 a in the different slots 13.1 and 13.2 can then pass through holes 21 a in each case into a trough 22.1 or 22.2 respectively. These troughs are, as described heretofore for the trough 22, turned towards the nozzle plate 3. It follows that, in the left part of the arrangement according to FIG. 1 g, a material other than in the right part is conducted, so that different yarns are produced from one single spinning package 1, 2, 3.

According to the embodiment in FIG. 1 h, only one single core material 10 b, i.e. for the formation of the yarn core, is conducted from a material source 14″ to 16″ to the distribution system 1. For all the yarns which derive from the arrangement, therefore, one and the same core material 10 b is provided. In general terms, at least one material component is provided for larger areas of the spinning package, and other components are only used for smaller areas. It is of course also possible for other material sources, not shown, to be arranged in addition to the material source 14″ to 16″, in order to manufacture different yarn types. As a departure from the embodiment according to FIG. 1 b, the core material passes through a shaft 12 c (instead of the sheath material according to FIG. 1 b) into a distribution slot or several distribution slots 13′ respectively, and from these pass into core holes 21 c, which are screened by projections 23 as far as the outlet side of the perforated plate 2 against the troughs 22.1 and 22,2, as has already been explained in detail in the Description of FIG. 2a. Basically, it can be said that, as already indicated, in FIG. 1 g the distribution of the material to form several yarn sheaths is represented, and in FIG. 1 h the guidance of the material for the formation of yarn cores. For FIG. 1 g and 1 h, the principle applies to the designations selected that the holes 21 a, 21 c do not conduct core material, as represented in FIG. 2 a, but, conversely, sheath material or core material respectively, to the spinning nozzles 32. This results in yarns with different sheaths, whereby the core materials are identical or different depending on the number of core materials.

A similar configuration is represented in FIG. 1 k and 1 l, with the principle difference that the material 10 a for the formation of the yarn cores is conducted through the material sources 14 to 16 and 14′ to 16′, while only one single material source 14″ to 16″ is provided for the sheath material 10 b. The embodiment according to FIGS. 1 k and 1 l corresponds exactly to that in FIGS. 1 a and 1 b, whereby, however, the longitudinal slot 13 is subdivided into a first longitudinal slot 13.1 and a second longitudinal slot 13.2. Several such slots 13.1 and 13.2 are provided one behind another. This makes it possible for different core materials to be introduced into the distribution system from the spinning pots 16 or 16′ respectively and conducted onwards separately. With regard to the description of the individual components, as represented in FIGS. 1 k and 1 l and also 1 g, 1 h, reference is made by analogy to the Figure Descriptions of FIGS. 1 a and 1 b, as well as 1, 2, 2 a, 3, 3a. This results in yarns with different cores, whereby the sheath materials also can be different with multiple designs of sheath material sources. Basically, it can be said that with multi-component yarns the materials can be arranged in their fibre cross-section in such a way that no completely surrounded core is present.

To illustrate the guidance of the different materials in the configurations according to FIGS. 1 g, 1 h, 1 k, 1 l, in FIGS. 1 e and 1 f the disposition for the delivery of different materials is represented, whereby, as mentioned heretofore, from n-components n-x yarns can be produced. The material flow diagram in FIG. 1 e corresponds to that in FIGS. 1 g and h, whereby, in the embodiment, a first material 10 c is conducted for yarn sheaths and a second material 10 a for a further group of yarn sheaths, in each case in indentations 12 c or 12 a respectively. In addition, for all the yarns the same core material 10 b is introduced into an indentation 12 b, from where this material can be distributed over the entire length of the distribution system 1, in order to penetrate into individual core holes 21 a of a distribution plate 2.

The principle applies to a concept according to FIG. 1 e, as well as for the other concepts already described heretofore, that the different materials derive from different sources 14 to 16, 14′ to 16′, and 14″ to 16″. The slots 12 a, 12 b, 12 c on the inlet side pass in each case into outlet side longitudinal slots 13, 13′, 13″, which communicate with the different holes, i.e. sheath holes 21 c or core holes 21 a respectively. From FIG. 1 e it can further be seen that, as represented by broken lines in the lower part of the perforated plate 2, a connection pertains from the different holes mentioned to the core capillaries 25 a or sheath capillaries 25 c respectively. The systems of holes for the core material or sheath material respectively, as well as of capillaries 21, 25 respectively, are, as diagrammatically shown, grouped together for preference in separate groups. It is possible, for example, for a hole pattern of capillaries to be grouped together with three core capillaries and three sheath capillaries indicated in the periphery in one group, as shown at the bottom left, while another group of holes or capillaries respectively, as diagrammatically represented in the nozzle plate 2 in the right-hand part, with four core holes and six sheath holes in an example embodiment, can be grouped together in a second group in accordance with the right-hand block of holes in the perforated plate 2. A perforated plate 2 can of course also be subdivided into several sections, as is indicated by the broken line in the middle of the perforated plate 2 between the hole groups 21, 25 or 21′, 25′ respectively.

A similar representation is shown in FIG. 1 f, whereby only one single sheath material 10 b is distributed through passage apertures 12 b or slots 13″ respectively, over the entire width of a distribution system 1 or a hole system 3 respectively. This sheath material passes further through sheath holes 21 a, b into sheath capillaries 25 c in the perforated plate 2. In addition to this, there are two material flows of core material 10 a, 10 c from sources 14 to 16 or 14′ to 16′ respectively, which can only be spread to a limited degree, in accordance with the representation of the passage apertures 12 c, 13′, or 12 a, 13 respectively, arranged in a staggered manner. These different core materials 10 a or 10 c respectively pass accordingly through core holes 21 c to the core capillaries 25 a in the perforated plate 2, and further through appropriately designed spinning nozzles 32 in accordance with FIG. 3 a, which are located aligned with the holes or capillaries respectively.

It is understood that, with regard to the material distribution of n materials from n sources (n>2), basically no limits are set. For example, the different materials do not necessarily have to be present in an arrangement concentric to one another in the finished yarn, which means that the core and sheath holes referred to according to the definition do not need to be positioned in such a way that in each case core holes are located in the inner area and sheath holes in the outer area. A multicomponent yarn can also be designed in such a way that what are referred to as the core holes are located in the vicinity of the line of alignment of the spinning nozzles 32, next to what are referred to as laterally further removed sheath holes, so that virtually no concentric surrounding of the core components by sheath components occurs.

The different variants described can be realised by a multicolour machine (such as a tricolour machine), with which the tricolour spinning nozzles are replaced by multi-component spinning nozzles. A multicolour machine can in this way be uprated to a multi-component machine. In particular, a tricolour machine can be refitted to become a two-component machine. The refitting consists solely of the spinning package, consisting, for example, of a distribution system 1, a perforated plate system 2, and a spinning plate system 3, is composed in accordance with the foregoing Description. In this way, yarns can be manufactured in which, for example, the core consists of non-coloured polymer, or the sheath of different-coloured polymers, or whereby different types of polymers form the core.

For preference, in this situation three extruders with metering devices are equipped so as to dye the melts. It is also possible, however, for other numbers of extruders to be provided. With conventional multicolour machines it is usual for three different-coloured melt flows to be guided in melt lines to the spinning beam, where a further distribution takes place before feeding into the spinning nozzles. The different coloured melts are conducted separately, so that they pass to the spinning nozzles in spatially separated areas.

Now, as mentioned, the spinning nozzles of multicolour spinning machines according to the invention are replaced by spinning nozzles for multi-component yarns. From each capillary, as described, a multicomponent filament can emerge. Thanks to the combination of components of multicolour machines and components of machines for the manufacture of filaments from several material components, any desired combinations and therefore any desired yarn types can be manufactured in one and the same spinning packages.

In practice, the following preferred variants can be used:

1. Bicomponent Yarn on a Tricolour Spinning Machine

With the use of a tricolour spinning machine for bicomponent yarn, at least one extruder is used for the melting out of the polymer for the core of the bicoloured yarn. The remaining extruders are used for melting out the sheath polymer. Each polymer flow is conducted in a melt line to the spinning beam In the spinning beam the melt flows are further divided and then a part flow from each polymer is conducted into the spinning nozzle. In the spinning nozzle the polymer flows are brought together to form a bicoloured yarn. On the assumption that an extruder is used for the core material, a material proportion of the core results in each filament of approx. 33% and a material proportion of the sheath of approx. 67%.

Larger material proportions of the core in each filament are attained if, on the tricolour spinning machine, two extruders are used for the core material and one extruder for the sheath material. In this case, the material proportion of the core in each filament amounts to approx. 67% and that of the sheath to approx. 33% (see FIG. 1 c).

The proportions given above apply to the use of spinning pumps of the same size for all polymers and for the same revolution speeds of the spinning pumps. For the person skilled in the art it is clear that, with other spinning pump sizes and/or other spinning pump revolution speeds, the material volume flows can be controlled by each extruder, and the material ratio of core material to sheath material can be selected at will.

2. Bicomponent Bicolour Yarn on Tricolour Spinning Machine

If, on a tricolour spinning machine being used for bicomponent yarn, one extruder is used for the core material, it is possible for sheath material with different colour additives (master batch) to be processed on the two remaining extruders. In this case, bicomponent bicolour yarn is then spun. The core proportion amounts to about 33% and the sheath proportion of each colour to 33% each, i.e. a total of approx. 67%. These proportions can be varied at will, as required, and depending on the machine design.

2 a) Bicomponent Yarn with Different Sheath Polymers on Tricolour Spinning Machine

By analogy with Point 2 above, it is possible for different polymers to be used in the sheath on the two remaining extruders. This means that a part of the filaments can be given substantially different properties, such as, for example, electrical conductivity, shrinkage behaviour, chemical affinity, etc.

3 Bicomponent Yarn with Different Cores on Tricolour Spinning Machine

If one extruder is used on the tricolour spinning machine in use for bicomponent yarn, it is possible for different types of core material to be processed on the two remaining extruders. In that case, bicomponent yarns with different core materials are spun. The core material amounts to approx. 33%. With half of all the filaments, the core is made of material 1, and with the other half of the filaments the core is made of material 2. The core materials may only be distinguished in the colour. For preference, however, they also differ in their physical properties in order to generate particular added value in the use of the end products. These properties include electrically conductive additives, anti-bacterial active substances, polymers with different shrinkage behaviours, etc.

It is therefore possible, according to the invention, for multicolour machines with n extruders (or n different types of melt flows with n≧3 to be realised, which serve to manufacture bicomponent yarns. In this situation, the following bicomponent yarns can be spun:
1. Core-sheath; whereby all the filaments are the same
2. Core-sheath; whereby core is the same with all the filaments and sheath can be different
3. Core-sheath; whereby sheath is the same with all the filaments and core can be different
4. Core-sheath; whereby the sheath and the core can be different.

By the use of the devices described according to the invention, it is also possible for multicomponent yarns (core/sheath) to be manufactured, in which only the sheath or the core is coloured.

Usually, the colouring is effected, for example with carpet yarns, by the addition of dye during spinning (spin dyeing) or when the yarn or carpet is completed (yarn colouring, printing, piece dyeing). The dyeing process is then concluded when the dye is completely and uniformly distributed in the yarn. The costs of the dye can come out to be the same as the costs of the polymer. If it proves possible for the dye to be manufactured with a device or system according to the invention, a substantial reduction in costs can be achieved. The possible savings can be broken down as follows:

1. Bicomponent Yarn with Dyed Sheath

The dyeing of a thin sheath layer of the filament can be sufficient on its own to provide the colour for the yarn.

If, during the spin-dyeing of core-sheath yarn, only the sheath is manufactured from a polymer, which is mixed with an additive (master batch), it is possible, with a core-sheath ratio of 50:50 for half the dye to be saved, which means a reduction in raw material costs of approx. 12 to 25%.

2. Bicomponent Yarn with Dyed Core

Because polymer is frequently transparent, it is possible for the dyeing to take place by way of the spin-dyeing of core material. If, during the spin-dyeing of core-sheath yarn, only the core is manufactured from a polymer, which is mixed with master batch, it is possible, with a core/sheath proportion of 50:50 for half of the dye to be saved, which means a reduction in raw material costs of approx. 12 to 25%.

A further problem with dyed or coloured yarn is what is referred to as colour-fastness. This is understood to mean the loss of colour (rubbing off on contact) or bleeding (washing out during wet treatment). If the spin-dyed core is now surrounded by a colourless sheath, the colour fastness will be improved. Accordingly, the possible savings lie not only in a reduction of the dye, but also the used value of the yarn will be increased, or a more economical dye can be used.

3. Bicomponent Yarn for Piece Dyeing

The use of core-sheath yarn for piece dyeing allows for the use of sheath polymer with colour affinity for one specific dye class only. This can be achieved if the dye is absorbed only in the sheath, and the required dye volume is reduced accordingly.

With the manufacture of anti-static yarns, too, the use of means according to the last (fourth) embodiment of the invention also allows for substantial costs reductions to be achieved. It is possible, for example, for anti-static material to be used in the manufacture of yarns with different sheaths only in a part of the different sheath components, so that the anti-static properties will still be provided even with material savings of the anti-static material. It is also possible to restrict the application in general only to the material in the sheath with anti-static effect. In addition, with the distribution of a spinning package over several hole systems, it is possible, as mentioned in connection with the Description of FIG. 1 f, for the anti-static material to remain restricted to an individual hole group 3.

1. A method for the manufacture of a filament yarn (10) or a fibril for a filament yarn by means of a spinning device, whereby at least two liquified components or materials (10a, b) are conducted through a number of capillaries (25 a, 25 c) to a spinning capillary (32), characterized in that the minimum of two liquified components or materials (10a, b) are conducted in each case through a number of capillaries (25 a, 25 c) to the spinning capillary (32), whereby a group of inner capillaries (25a) serve to form a connected filament core and whereby at least one further material (10b) forms a sheath around the filament core (10′a, 10″a).

2-22. (canceled)
